(19) United States
(12) Patent Application Publication
(10) Pub. No.: US 2013/0333661 A1
(43) Pub. Date: Dec. 19, 2013

(54) METHOD FOR OPERATING AN INTERNAL COMBUSTION ENGINE

(71) Applicant: DAIMLER AG, Stuttgart (DE)

(72) Inventor: Juergen Fischer, Munich (DE)

(73) Assignee: DAIMLER AG, Stuttgart (DE)

(21) Appl. No.: 13/783,308

(22) Filed: Mar. 3, 2013

Related U.S. Application Data
(63) Continuation-in-part of application No. PCT/EP2011/004444, filed on Sep. 3, 2011.

(30) Foreign Application Priority Data
Sep. 16, 2010 (DE) 10 2010 045 689.6

(51) Int. Cl. F02B 17/00

(52) U.S. Cl. CPC F02B 17/005
USPC 123/295

(57) ABSTRACT

In a method for operating an internal combustion engine with a plurality of combustion chambers, wherein a discrepancy between an actual operating performance and a target operating performance of at least one of the combustion chambers is detected, the ignition point is shifted in only the combustion chamber that has the discrepancy in order to influence combustion so as to compensate for the discrepancy.

This is a Continuation-In-Part Application of pending international patent application PCT/EP2011/004444 filed Sep. 3, 2011 and claiming the priority of German patent application 10 2010 045 689.6 filed Sep. 16, 2010.

### BACKGROUND OF THE INVENTION

The invention relates to a method for operating a combustion engine with a plurality of cylinders upon detection of a discrepancy between an actual performance and a target performance of a cylinder.

DE 10 2005 046 955 B3 discloses a method for detecting a misfire in a combustion chamber of a cylinder of an internal combustion engine with several cylinders, wherein a misfire in one of the cylinders is recognized depending on at least one parameter of the combustion engine. Furthermore, a measurement for a fluctuation in the spark plug burning time is detected, which is assigned to the cylinder in which the misfire was recognized. Moreover, further measurements for the fluctuations in burning times of different spark plugs are detected, which are assigned to other cylinders. Furthermore, depending on the measurements, a cause of defect for the misfire is detected, which is due to an ignition system of the combustion engine.

It is the principal object of the present invention to provide a method for operating an internal combustion engine, so as to ensure smooth engine operation for a high ride comfort and low fuel consumption of the internal combustion engine.

### SUMMARY OF THE INVENTION

In a method for operating an internal combustion engine with a plurality of combustion chambers, wherein a discrepancy between an actual operating performance and a target operating performance of at least one of the combustion chambers is detected, the ignition point is shifted in only the combustion chamber that has the discrepancy in order to influence combustion so as to compensate for the discrepancy.

In other words, only a measure that is specific for the fuel combustion in the ailing combustion chamber is carried out, so as to compensate for the discrepancy detected in the respective combustion chamber(s). In the remaining combustion chambers of the internal combustion engine, no measures, or at least none of these measures, are carried out. In this way, the discrepancy in the combustion chamber can be compensated for individually while the other combustion chambers are still operated optimally with respect to fuel consumption. Since any such discrepancy could have a negative effect on the ride comfort of passengers of a motor vehicle, in particular a personal motor vehicle, the method thus ensures, on one hand, the high ride comfort and, on the other hand, maintains an efficient operation and low fuel consumption and low CO₂ emissions of the internal combustion engine.

If, for example, the combustion engine is operated with excess air, wherein the combustion-air ratio Lambda (λ) is greater than 1, it is particularly likely for the internal combustion engine, particularly when it is a spark ignition engine, to experience a discrepancy between the actual and target operating performance. This discrepancy is, for example, a misfire of a combustion operation taking place in the combustion chamber(s), an undesirably high operating irregularity in the combustion engine, an undesired pressure or pressure distribution in the combustion chamber and/or an undesired spark plug burning time for igniting a mixture in the combustion chamber or the respective combustion chambers. The same applies for a warm-up period of the combustion engine, during which the discrepancy or discrepancies can occur at a relatively high level of probability.

If the discrepancy only occurs in one or some of the combustion chambers, whereas the remaining combustion chambers show no discrepancy and no such abnormalities, the method according to the invention is able to carry out corresponding measures to compensate for the discrepancy (which generally has a negative effect on fuel consumption) just in the affected but not in all of the combustion chambers.

Such measures to compensate for the discrepancy are, for example, measures that influence an injection, in particular a direct injection, of an amount of fuel into the combustion chamber that has the discrepancy. To compensate for the discrepancy, the amount of the fuel which is to be injected into the combustion chamber that has the discrepancy can be adjusted. When, for example during operation of the internal combustion engine, a specific amount of fuel is injected into the combustion chambers of a particular cylinder, and then a discrepancy between the actual and target operating performance of this cylinder is detected, after the detection of the discrepancy the amount of fuel injected is, at least temporarily, altered with respect to the amount before the detection of the discrepancy. Thus, for example, if before the discrepancy has been detected, the cylinder is operated with excess air (λ>1), it is then operated at a comparatively lower combustion-air ratio (in particular a stoichiometric combustion-air ratio) after the discrepancy has been detected. The remaining combustion chambers that have no discrepancy between their actual and target operating performance, can still be operated with excess air and a high combustion-air ratio, so as to keep the fuel consumption of the combustion engine low.

To compensate for the discrepancy, it is also possible to adjust, in particular to shift, the time at which the amount of fuel is injected, into the combustion chamber which has the discrepancy. If, for example, in one of the combustion chambers, fuel is injected at a specific rotational position of a crank shaft of the combustion engine, which discrepancy is detected by the detection device, then, after the detection of the discrepancy, the amount of fuel is injected into the combustion chamber, at an injection point that differs from the specific rotational position at which the fuel was injected before the detection of the discrepancy. In this way, the discrepancy in this combustion chamber can be compensated for and a high level of ride comfort for the combustion engine can be maintained, while the other combustion chambers, particularly with respect to their fuel consumption, can be operated optimally, resulting in low fuel consumption of the combustion engine and low CO₂ emissions.

To compensate for the discrepancy, it is also possible to adjust, in particular shift, an ignition point of the fuel in the combustion chamber that has the discrepancy. If the mixture is ignited by means of induced ignition, the ignition point denotes the point in time and rotational position of the crank shaft, at which the mixture is ignited by means of an ignition device. If the mixture is ignited by auto-ignition, the ignition point, i.e. the rotational position of the crank shaft at which the mixture is ignited, is dependent on the time point and rotational position at which the fuel is injected into the combustion chamber.

If, as the discrepancy, a discrepancy between an actual spark plug burning time and a target spark plug burning time for igniting the mixture is detected, an excess or a lack of fuel during ignition of the mixture can be identified by comparing the compiled actual spark plug burning time with the spark plug burning times of the other combustion chambers that have no discrepancy. From this, a targeted measure or adaptation of the combustion that has the discrepancy can be undertaken, wherein, for example, fuel injection close to the ignition is displaced or an amount of fuel injected close to the ignition can be adjusted.

The invention will become more readily apparent from the following description of two preferred exemplary embodiments with reference to the accompanying drawings. The features and feature combinations disclosed in the description alone can be used not only in the respective specified combination, but also in other combinations or individually, without exceeding the scope of the invention.

### BRIEF DESCRIPTION OF THE DRAWINGS

FIG. 1: shows a schematic diagram of an internal combustion engine having four cylinders, into which fuel is injected directly to form an air-fuel mixture, after which the air-fuel mixture is ignited;

FIG. 2: shows a further schematic diagram of the internal combustion engine according to FIG. 1, wherein an injection point of only one of the cylinders is shifted to inject the fuel into this cylinder with respect to FIG. 1; and

FIG. 3: shows a schematic diagram of the internal combustion engine according to FIG. 1, wherein an ignition point of only one of the cylinders is shifted for igniting the air-fuel mixture with respect to FIG. 1.

### DESCRIPTION OF EXEMPLARY EMBODIMENTS

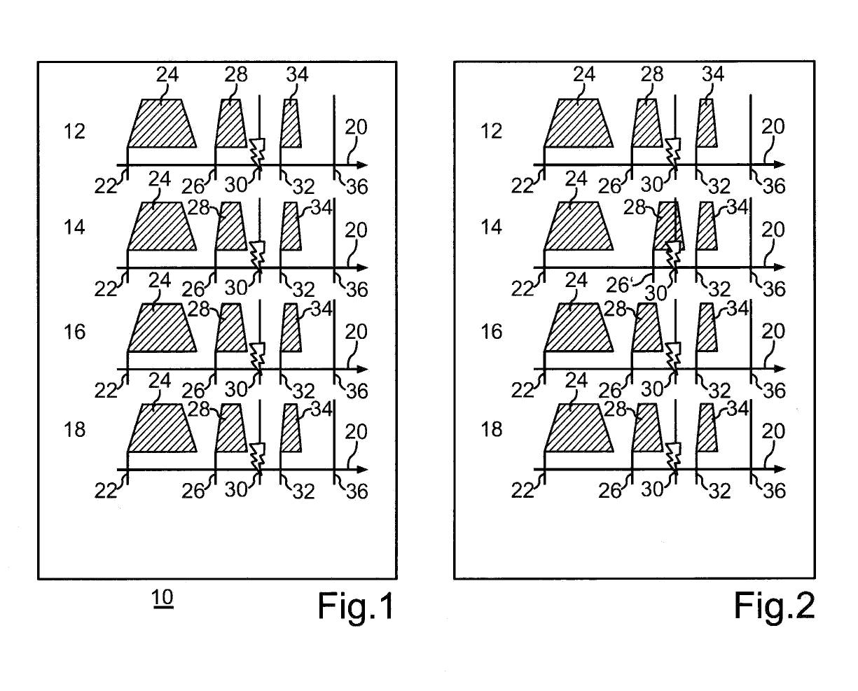

FIG. 1 shows a combustion engine 10 with a first cylinder 12, a second cylinder 14, a third cylinder 16 and a fourth cylinder 18. During the operation of a combustion engine 10, a crank shaft rotates, which is connected, to pistons via corresponding connecting rods, which are disposed in the corresponding cylinders 12, 14, 16 and 18 in a translationally moveable manner. The arrangement provides for a conversion of the translational movement of the pistons in the cylinders 12, 14, 16 and 18 into a rotational movement of the crank shaft.

The crank shaft rotating during an operation of the combustion engine 10, which is in the form as a reciprocating piston engine, has various rotational positions that are denoted as crank angle degrees ([°KW]). These crank angle degrees are depicted on the respective process arrows 20 in FIG. 1. A specific amount 24 of fuel is directly injected into the respective cylinders 12, 14, 16, 18 at a specific crank angle degree 22. By injecting the fuel into a cylinder, an air-fuel mixture is formed, which is ignited at a crank angle degree 30. The crank angle degree 30 is also denoted as an ignition point. At a further crank angle degree 32, a further amount 34 of fuel is injected into the cylinder; this is a post-injection of fuel. During the injection and ignition, the corresponding pistons move in the respective cylinders 12, 54, 16, 18 toward a top dead center position, where they are shortly in a rest position and then move in the direction toward the bottom dead center. The pistons reach the top dead center at a rotational position 36 of the crank shaft, which is denoted as the top dead center (TDC).

The combustion engine 10 is operated, for example, in a so-called lean operation. In this way, it is operated, for example, in a stratified charge mode of operation. A stratification layer is thus present in the cylinders 12, 14, 16, 18, which has a non-existent or only a very small amount of fuel, and thus a very high combustion-air ratio, which is larger than 1. This stratification layer has for example an air/fuel ratio outside of the ignition limits and cannot be ignited by induced ignition with an ignition device. However, there is a further stratification layer present in the cylinders 12, 14, 16 and 18, which is thicker than the first stratification layer and has a lower combustion-air ration. This stratification layer is within the ignition limits and can be ignited, and thus activated, by an ignition device at the rotational position 30. Due to this ignition and activation of the ignitable stratification layer, the first stratification layer is also activated and ignited, which leads to an expansion of the air-fuel mixture and thus to a movement of the pistons in the cylinders 12, 14, 16 and 18. On the whole, however, excess air does prevail in the cylinders 12, 14, 16, 18, and thus an overall combustion-air ratio of greater than 1 is present, such that the combustion engine 10 is actually operated with only low fuel consumption at a low level of emissions.

It is also possible for a homogenous stratification to be present in the cylinders 12, 14, 16 and 18 as a lean operation, wherein the fuel is fully dispersed and essentially uniformly mixed with the air forming a lean mixture. For facilitating ignition, a further stratification area with additional fuel is injected in the region of the ignition device, which is for example a spark plug, and this further stratification has a combustion-air ratio that is lower than that of the mixture first established and can be ignited by the spark plug, whereby then also the first homogenous mixture or stratification area is also ignited. Also during the homogenous stratification operation, there is generally excess air present, and thus a combustion-air ratio in the cylinders 12, 14, 16 and 18 that is greater than 1 can b achieved. This also leads to low fuel consumption of the combustion engine 10.

During such a lean operation (stratification operation/homogenous stratification operation) and also during a warm-up period of the combustion engine 10 after a relatively long shutdown time, for example, the second cylinder 14 may have an actual operating performance that is different from a desired target operating performance. This, for example, may cause misfiring, increased operating irregularity, undesired pressure or combustion events in the cylinder 14 and/or an undesired burning time of an ignition spark generated by means of the ignition device, in particular the spark plug. The remaining cylinders 12, 16 and 18 have no such a discrepancy. In order to compensate for the discrepancy in the operating performance of the second cylinder 14, while simultaneously keeping the fuel consumption of the combustion engine 10 low, as is depicted in FIG. 2, the rotational position 26 of fuel injection only the second cylinder 14 is shifted, while the fuel amounts 28 in the remaining cylinders 12, 16 and 18 are injected at the rotational position 26 as before.

As apparent from FIG. 2, the amount 28 in the cylinder 14 is injected at a rotational position 26′ in the cylinder 14 after the discrepancy has been detected. The rotational position 26′ is a rotational position of the crank shaft which is later than the rotational position 26. In other words, the rotational position 26, and thus the injection point for injecting the amount 28, is shifted late that is, toward the rotational position 30 or toward the ignition point that is toward the rotational position 36 or the top dead center position. In this way, the discrepancy in the cylinder 14 may be compensated for, while the other cylinders 12,16 and 18 are still operated optimally, in particular with respect to their fuel consumption. Thus the internal combustion engine maintain a high ride comfort and simultaneously consistently low fuel consumption, which is accompanied by low CO₂ emissions.

Alternatively, or additionally, it is possible to alter the amount 28 of fuel injected into the combustion chamber. When the discrepancy is detected, an amount in the cylinder 14 can be injected, which, for example, is smaller or larger than the amount 28 that has been inserted into the cylinder 14 before the discrepancy was detected. This, as well as the first and/or other measures, is carried out generally only temporarily and, with respect to the respective cylinder, the lean operation can even be ended, for example, and an operation of the cylinder 14 with stoichiometric combustion can be established, at least temporarily.

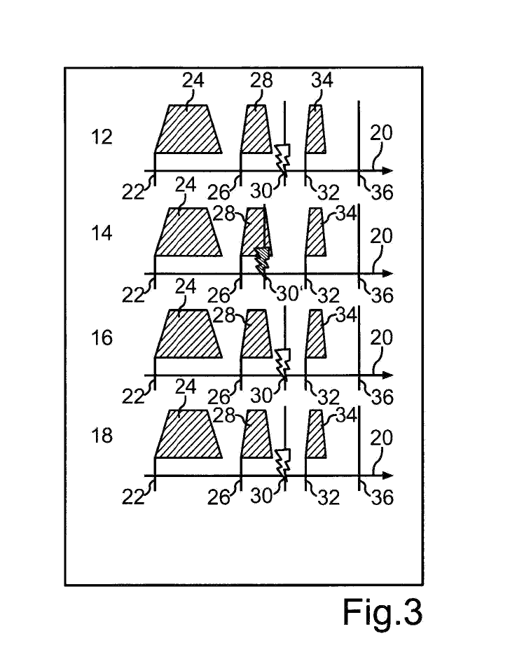

FIG. 3 shows a further potential measure to compensate for the discrepancy between the actual operating performance of the cylinder 14 and the desired target operating performance. As shown in FIG. 3, the air-fuel mixture is ignited at a rotational position 30′, which is earlier than the rotational position 30 when the crank shaft is being rotated. In other words, the rotational position 30, and thus the ignition point, is shifted early so as to be farther from the top ignition dead center. This early shifting is also only carried out in the respective (second) cylinder, while the other cylinders 12, 16 and 18 are operated optimally as before, in particular with respect to low fuel consumption. A particularly high level of operating regularity can be maintained by these measures, as well as low fuel consumption of the combustion engine 10.

What is claimed is:

1. A method for operating an internal combustion engine with a plurality of combustion chambers (12,14, 16, 18), wherein a discrepancy between an actual operating performance and a target operating performance in at least one of the combustion chambers (12, 14, 16, 18) is detected, said method comprising the steps of:
performing, in order to compensate for the discrepancy, at least one measure, which influences combustion in only the combustion chamber (12,14, 16, 18) which has the discrepancy, and
during a lean operation (stratified operation/homogeneous stratified operation) of the internal combustion engine (10) compensating for the discrepancy by shifting an ignition point (30, 30′) of the combustion chamber (12, 14, 16, 18) that has the discrepancy so as to be at a different point from a top ignition dead center position (36).

2. The method according to claim 1, wherein to compensate for the discrepancy, at least one measure is carried out, which influences the injection of an amount (24, 28, 34) of fuel injected into the combustion chamber (12,14, 16, 18) that has the discrepancy.

3. The method according to claim 2, wherein to compensate for the discrepancy, the amount (24, 28, 34) of fuel which is injected, into the combustion chamber (12, 14,16, 18) that has the discrepancy is adjusted.

4. The method according to claim 2, wherein to compensate for the discrepancy, a time point of injection the amount (24, 28,34) of fuel which injected directly, into the combustion chamber (12, 14, 16,18) that has the discrepancy is shifted.

5. The method according to claim 1, wherein as a cause for a discrepancy between an actual operating performance and a target operating performance at least one of a misfire, a deviation of an actual pressure from a target pressure, a deviation of an actual pressure flow from a target pressure flow and a deviation of an actual spark plug burning time from a target spark plug burning time is detected as the discrepancy.
